(19) United States
(12) Patent Application Publication
(10) Pub. No.: US 2011/0163140 A1
(43) Pub. Date: Jul. 7, 2011

(54) TRANSPORT DEVICE

(76) Inventor: Ulrich Wystrach, München (DE)

(21) Appl. No.: 12/737,962

(22) PCT Filed: Sep. 3, 2009
(86) PCT No.: PCT/EP2009/006400

§ 371 Date: Mar. 4, 2011

(30) Foreign Application Priority Data
Sep. 5, 2008 (DE) 20 2008 011 894.8
Aug. 20, 2009 (DE) 20 2009 011 325.6

(51) Int. Cl. B60R 7/00

(52) U.S. Cl. 224/281; 224/400

(57) ABSTRACT

A transport device for accommodating at least one transport good, such as a bicycle, for transport on a vehicle, wherein at least one bracket is provided for connecting the same to a part of the transport good, and wherein a support is provided, allowing a displacement of the transport device with respect to the vehicle.

### FIELD OF THE INVENTION

The invention relates to a transport device for the transport of heavy and/or bulky objects, especially to accommodate at least one bicycle in a vehicle, where at least one bracket is provided for connection to the object.

### BACKGROUND OF THE INVENTION

The transporting of large objects, such as bicycles, is usually done at present on the roof or on the tail end of a motor vehicle, typical of bicycles. In this case, the object being transported is exposed to the weather, and furthermore it must be protected against theft. When loading or unloading there is the danger of damaging the motor vehicle with the good being transported. The transport of such goods on the roof or on the tail end has a detrimental effect on the air drag of the vehicle. The additional wind noise is also disturbing. The handling of tail and roof brackets is difficult and cumbersome. In the case of a tail bracket, the access to the tail gate or the trunk space is greatly impeded.

Utility model DE 20 2006 006 847 U1 discloses the transport of bicycles in the interior of a motor vehicle. A bicycle bracket consists of a fixation device and detent elements, which are fastened to the inner wall in the vehicle. A fixation device to receive the bicycles via the front fork is anchored in the detent elements. The loading of the bicycle bracket with the bicycles must be done relatively uncomfortably in the inside of the vehicle. Lifting the bicycles into the cargo space is an extreme exertion and is generally done in a bent-over posture, which causes a substantial stress on the spine, especially the disks.

### SUMMARY OF THE INVENTION

Given this prior art, the problem of the invention is to provide a transport device to accommodate at least one bicycle for transport in a vehicle, which offers an improved handling when loading the vehicle and/or when loading the device.

The problem is solved according to the invention in that at least one bracket for connection to one part of the transport good is provided on the transport device to accommodate at least one object being transported or good for transport in a vehicle, as well as a support that allows a displacement of the transport device relative to the vehicle. An especially preferred transport good is a bicycle.

As the vehicle, one will consider primarily passenger cars, in whose interior the object or good can be transported. If the object is a bicycle, one or two wheels of the bicycle may be removed for the transport, especially in the case of station wagons, liftback vehicles, SUVs, light trucks, trucksters, campers and off-road vehicles, etc. Since the support enables a displacement of the device relative to the vehicle, this can advantageously be shoved into and pulled out from the vehicle, especially with at least one transport good already in place. The displacement of the transport device relative to the vehicle can occur, for example, along a guide at the vehicle, but according to a preferred embodiment the transport device can move freely in the vehicle. Also preferably the support is realized in the form of rollers and/or slides, which facilitates the displacement.

The transport device of the invention affords a possibility of transport of bicycles, in particular, in the interior of motor vehicles, not requiring any costly accessory devices to be installed beforehand, it can be installed in any given vehicle and it is simple and comfortable to use, and also its loading and unloading can be done easily and safely by a single person. The transport device of the invention picks up the transport good and can be shoved into the vehicle like a drawer. With the transport device of the invention a plurality of goods, such as one or more bicycles, can be loaded and unloaded or connected especially easily outside of the vehicle. Therefore, the extremely laborious and back-stressing lifting of the transport good in the bent-over position to place it inside, the vehicle is no longer necessary. The transport device is protected against a displacement or slippage during travel by means of transport securing devices that are present in the vehicle, such as lashing straps and lugs or hooks present in the vehicle.

Via a bracket, the particular object or transport good is securely connected to the transport device, and any suitable part of the transport good can be used for this. According to another preferred embodiment, it carries a clamping beam or bracket beam, which has at least one bracket that can be adjusted along the clamping beam in order to adapt to different kinds of objects, such as types and sizes of bicycles. Especially preferably, socket pins are provided, which are inserted or fastened in boreholes and/or at least one groove of the clamping beam. One benefit of this embodiment is that the position of the transport good or the brackets along the clamping beam is freely selectable, so that the transport device can be variably adapted to different kinds of objects or transport goods, such as bicycle types, and the space inside the vehicle can always be used optimally, for example, by placing several transport goods close together. Preferably, the clamping beam is therefore arranged transversely to the direction of travel. The clamping beam is preferably designed so that several brackets can be installed for possibly different objects, especially bicycles. The clamping beam preferably has a width of at least 150 or 200 mm. The maximum width depends on the width of the cargo door opening of the particular vehicle. Preferably, the clamping beam can be variably adjusted in its width, for example, it is made from individual telescoping parts.

In one preferred embodiment, the transport device of the invention has a least one clamping beam at each of its opposite ends, so that in the event that the transport good is a bicycle at least two bicycles can be transported in especially space-saving fashion pointing opposite each other. The width of this beam depends on the desired number of bicycles being transported. Therefore, in an especially preferred embodiment, it is detachably connected to the entire transport device, so that it can be replaced by a broader or narrower one as needed and so adapted to the number of bicycles being transported. Furthermore, the transport device can also be adapted in this way to the width of the vehicle being used.

According to another preferred embodiment, at least one of the brackets is provided for a form-fitting or nonpositive connection to a fork dropout and/or a rear dropout of the bicycle. Especially preferably, when there are several bicycles present, a first part of the brackets is provided for connection to the fork dropout and a second part of the brackets for connection to the rear dropout, so that the bicycles can advantageously be arranged in different orientations, preferably in alternating orientations. Basically it is also possible, according to the invention, to stagger the brackets in the lengthwise direction (along the bicycle), so that parts sticking out to the side such as pedals do not interfere with each other, which would result in a wider stowing area. The tying is done especially advantageously by means of familiar quick connectors or toggle connectors. The corresponding wheel can be removed for this, or remain mounted on the bicycle, if space conditions in the vehicle allow this. The second wheel generally remains on the bicycle, but if needed it can also be removed. Advisedly, the rear wheel remains on the bicycle. Alternatively or additionally, at least one of the brackets is outfitted to make a form-fitting and/or nonpositive connection with a clamping strap that encloses a lower tube of the bicycle frame.

In another embodiment of the invention, the transport device has a tensioning or stretching device, with which the height of a bicycle that has a spring suspension can be lowered. Such a stretching device is, for example, a cable or lever stretcher, which is connected to a part of the bicycle above the springs, such as the handlebars or bicycle frame, and the transport device. This makes possible a transport in lower-built vehicles.

According to another preferred embodiment, a front parking surface is provided on the clamping beam, or the clamping beam is flat in configuration and itself forms a front parking surface, which facilitates the securing and loosening of the bicycles. The front parking surface can be formed, for example, by a board, a perforated plate, or also a stretched piece of canvas.

According to one preferred embodiment, a rear receptacle to support the bicycle is arranged at the rear end of the transport device of the invention or close to it. This can be in the form of simple cross braces, for example, or it can also be formed by a grill, a netting or piece of canvas, or a plate.

Alternatively or additionally, the rear receptacle preferably has at least one additional bracket for connection to a part of the bicycle. Thus, advantageously, it is possible to fasten a part of the bicycles being transported to the rear receptacle. Of course, one or more bicycles can also be fastened both to the front bracket and to the additional rear bracket at the rear receptacle.

Preferably, the additional supports are adjustable along the rear receptacle, and for this the rear receptacle especially preferably has boreholes and/or at least one groove. The fastening occurs, for example, by means of socket pins.

According to another advisable embodiment, the transport device has a supporting or connecting element extending longitudinally, especially in the driving direction of the transport vehicle, on which support, clamping beam, and rear receptacle are joined to each other. To take apart the transport device, the connection with support, clamping beam and rear receptacle can be detachable. In one simple embodiment, the connection or supporting element is in the form of a frame. The frame can be, for example, a tube frame, which is secured to the clamping beam and extends in the direction of the bicycles being transported, for example, to 30-100 cm, and transversely to this it is around 2-150 cm in width, for example, depending on the number of bicycles or the width of the transport good. The clamping beam is connected to the preferably U-shaped frame in this embodiment. With the frame, the transport device can be handled especially easily, in particular, it is easy to shove it into the vehicle and pull it out again.

Also preferred, a pedestal or supporting leg is provided at the side of the frame away from the support, which especially preferably is adjustable in height and/or can pivot, and can be locked in various positions by means of socket pins, for example. One benefit of this embodiment is that the frame at one end can be propped by the support on the cargo surface of the vehicle, while the folded-down supporting leg at the other end is placed on the ground. In this position, bicycles can be conveniently fastened to the transport device and released from it.

Also preferably, a supporting arm is pivoted on the frame. This serves, in particular, to support the bicycle, for example, in the area of its bottom bracket ball bearing race. Accordingly, the supporting arm is arranged especially preferably between the clamping beam and the supporting leg. Thus, adjustment and repair work on the bicycle can be done advantageously on the transport device.

According to another preferred embodiment, a transport case is provided to receive dismantled wheels of bicycles, which can be fastened by a detachable connection to the frame, a part of the bicycle, or the transport vehicle. Thus, one avoids mixing up or losing the dismantled wheels. The detachable connection is made, for example, by a Velcro band, a snap button, or a carabiner.

Also preferably at least one transport securement is provided which serves to fix the transport device and/or at least one bicycle in the vehicle, such as a lashing strap for connection to lugs in the vehicle.

In another embodiment of the invention, the frame of the invented transport device has a rear receptacle for supporting the bicycle.

Preferably, the rear receptacle has at least one additional bracket for connection to a part of the bicycle.

In another embodiment of the invention, the transport device has additional brackets, which can be adjusted along the rear receptacle.

In another embodiment of the invention, the transport device comprises a transport case to receive dismantled wheels of the bicycles, which can be fastened by a detachable connection to the frame or to a part of the bicycle.

In another embodiment of the invention, the transport device has a mechanism for lowering the height of the bicycle.

### BRIEF DESCRIPTION OF THE DRAWINGS

The invention will now be explained by means of drawings. The sample embodiments shown are only examples and do not restrict the general notion of the invention.

These show:

FIG. 1, a schematic representation of a first embodiment of a transport device of the invention;

FIG. 2, a perspective representation of a second embodiment of the transport device of the invention in a cargo space of a vehicle;

FIG. 3, a detailed view of a bracket of the transport device of the invention per FIG. 2;

FIG. 4, a detailed view of an alternative embodiment of the bracket;

FIG. 5, a schematic representation of another embodiment of the transport device of the invention;

FIG. 6, a schematic representation of a transport case according to another embodiment of the transport device of the invention;

FIG. 7, a perspective representation of another embodiment of the transport device of the invention with a bicycle arranged on it; and

FIG. 8, a simple configuration of a stretching device to reduce the height of the bicycle.

### DETAILED DESCRIPTION OF THE INVENTION

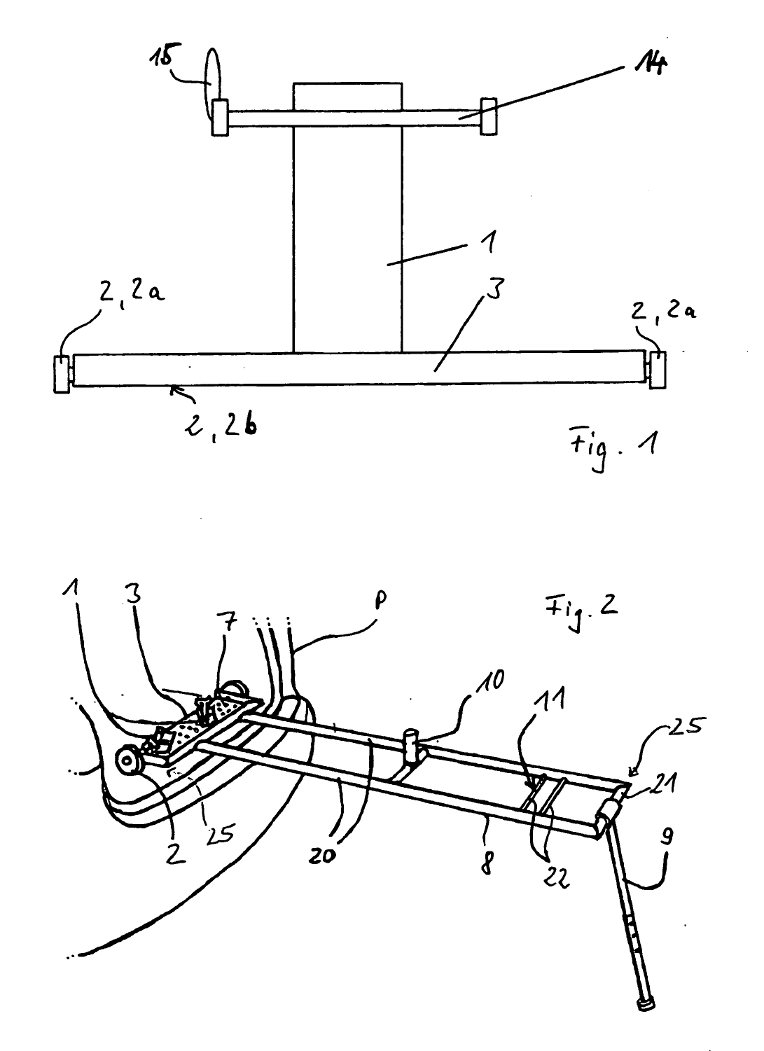

FIG. 1 shows schematically a simple embodiment of the transport device of the invention. The transport device has a bracket 1, which is provided for connection to a part of a bicycle (not shown). For this, the bracket 1 has, for example, a fork receptacle 14 with a quick stretcher 15. The fork receptacle 14 supports a fork dropout or a rear dropout of the bicycle, while the wheel does not necessarily have to be dismounted from the bicycle. Using the quick stretcher, the dropout is clamped in familiar fashion so that a form-fitting and nonpositive connection is produced, comparable to the fastening of the wheels on the bicycle.

The bracket 1 is mounted on a carrying structure of basically any desired kind. According to the invention, the transport device has a support 2, which allows it to move relative to a vehicle (not shown). In the embodiment shown, the support 2 comprises rollers 2a arranged at the sides. Alternatively or additionally, the transport device can also have slides 2b as the support 2. In an especially simple embodiment, a bottom of the supporting structure can be configured as a slide 2b, which as the support 2 enables a displacement of the transport device.

In the embodiment depicted, the supporting structure comprises a clamping beam 3, which carries the bracket 1, while the bracket 1 can be moved along the clamping beam 3, as will be explained more closely by the following figures. The clamping beam 3 can carry a plurality of identical or different brackets 1, it being advantageously possible to load several bicycles at the same time in one vehicle with the transport device of the invention.

FIG. 2 shows another embodiment of the transport device of the invention in a cargo space of a vehicle P in perspective view. The clamping beam 3 has a plurality of fastening receptacles 5, which are configured here as boreholes 5. The clamping beam 3 is configured as a perforated plate, for example, which at the same time serves as a front parking surface 7. One benefit is that the brackets 1 can be fastened at any desired borehole 5. In this way, the transport device can be adapted to two or more bicycles (not shown). In the example shown, two brackets 1 are fastened on the clamping beam 3. The type of fastening itself will be discussed later on. Rollers serve as the support 2, enabling the displacement of the transport device on the floor of the cargo space of the vehicle P. It becomes clear that one or more bicycles secured to the transport device can be comfortably shoved into the vehicle P and likewise be unloaded once again without requiring a lifting of the bicycles into the cargo space and out again. Such a lifting is especially laborious and stressful to the back, especially the disks, in the case of vehicles whose cargo space cannot be walked into on account of lack of height, such as station wagons, off-road vehicles, SUVs or liftback vehicles.

In the sample embodiment shown, the transport device furthermore has a frame 8, which is connected to the clamping beam and extends, for example, around 900 millimeters beyond the length of the vehicle. The frame 8 consists, for example, of U-shaped tubes, with two legs 20 running parallel at a spacing of around 200 millimeters and being joined by a web 21 at their end opposite the clamping beam 3. One benefit is that the transport device with bicycles on the frame 8 can be shoved into the vehicle P in the fashion of a drawer. To guarantee a secure standing of the bicycle, a rear receptacle 11 is preferably provided on the frame 8, which supports for example one wheel of the bicycle. The rear receptacle here consists of two cross braces 22 between the legs 20 of the frame 8. Alternatively, the rear receptacle 11 can be configured as a grill, a plate, a netting or a piece of canvas. Of course, it is also possible according to the invention to configure the rear receptacle 11 as a bracket. Here, after dismounting the second wheel, we place the second bicycle fork into the bracket, resulting in a lower stowage height. A supporting leg 9 can pivot and preferably be locked on the web 21 of the frame 8, which further increases the comfort of use, since the frame 8 is arranged almost in the horizontal position between the clamping beam 3 arranged in the vehicle's cargo space and the preferably height-adjustable supporting leg 9. A pivoting supporting arm 10 is mounted on the frame 8, serving as a support in the region of the bicycle's bottom bracket ball bearing race for adjustment and repair work on the bicycle, and in this way a driving of the bicycle can be advantageously activated, as the driven wheel can turn freely.

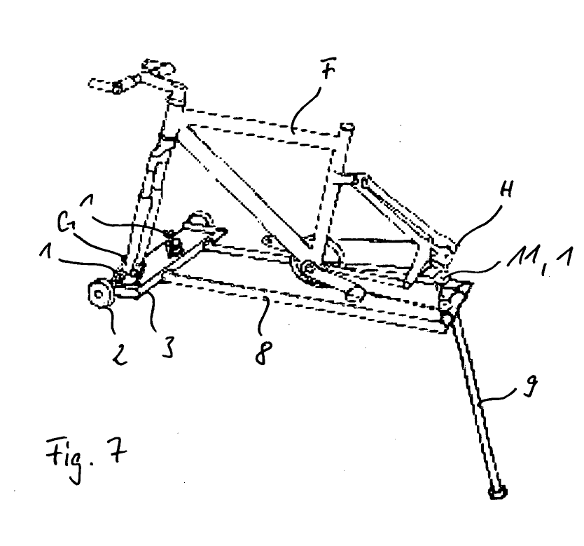

FIG. 3 shows a detail view of the bracket 1 according to FIG. 2, which serves for fastening at the fork dropout or the rear dropout of the bicycle (not shown). The fork receptacle 14 with the tension lever 15 is arranged on a beam 18. The beam 18 has a recess 16, through which a socket pin 4 is passed, being inserted into one of the fastening recesses 5 (see FIGS. 2 and 5) in order to secure the bracket 1 to the clamping beam 3 (FIGS. 2 and 5). The recess 16 can be configured as an elongated hole to facilitate the connection with the bicycle.

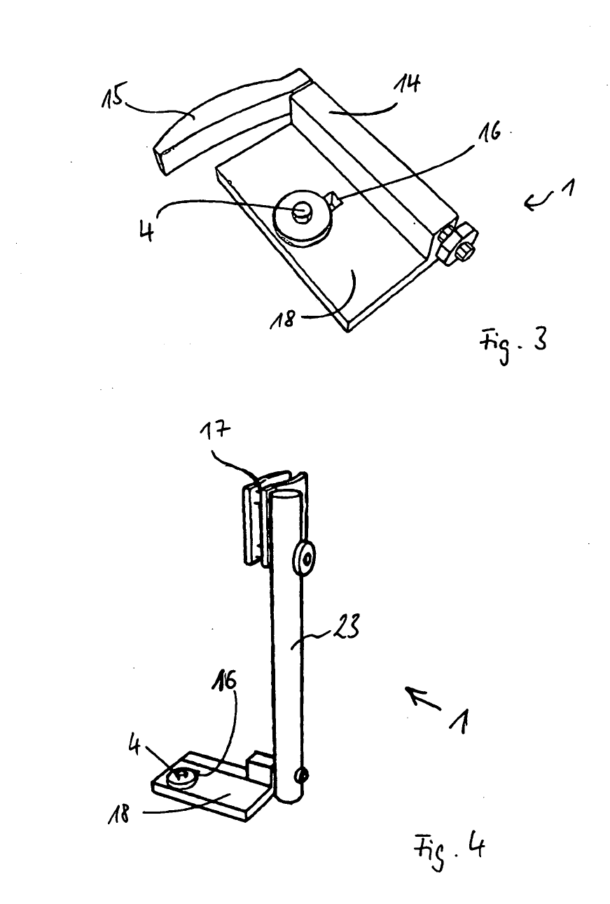

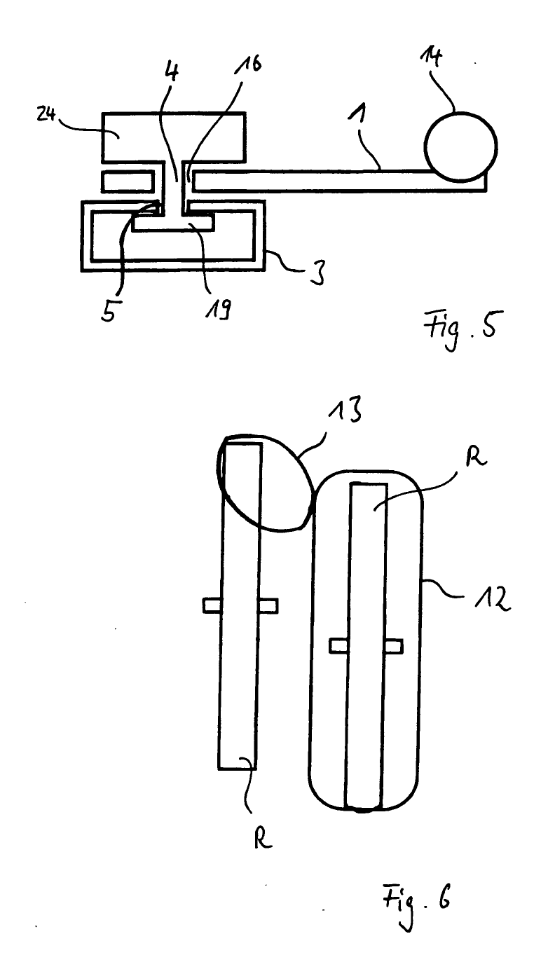

FIG. 4 shows a detail view of an alternative embodiment of the bracket 1. In this embodiment, the bracket 1 is designed to receive and secure one of the lower tubes of the bicycle (not shown) and has a tightening clip 17 for this, which is joined to the bear 18 via a connecting rod 23. The fastening of the bracket 1, again, is done by the socket pin 4 in the recess 16 in the beam 18.

FIG. 5 is a schematic representation of another embodiment of the transport device of the invention. The clamping beam 3 is configured as a rail with an undercut groove as the fastening recess 5. The position of the bracket 1 along the groove 5 is thus advantageously selectable at will. The bracket 1 with the fork receptacle 14 is anchored in the undercut groove 5 by a locking 19 on the socket pin 4 led through the recess 16. Thanks to a suitable toggle device (not shown), the position of the bracket 1 can be fixed, for example, by turning a knob 24. Otherwise, the bracket 1 can move freely along the groove 5 and it can also be removed from the clamping beam 3 by a preferably open end of the groove 5.

FIG. 6 shows a schematic representation of a transport case 12 according to another embodiment of the transport device of the invention. A dismounted wheel R is packed inside the transport case 12. The transport case 12 can be fastened to any desired part of the transport device or the bicycle (neither being shown) by a detachable connection 13, such as a strap with Velcro closure, a carabiner closure or snap buttons, as here for example on another wheel R still mounted on the bicycle.

FIG. 7 shows another embodiment of the transport device of the invention with a bicycle F arranged on it in perspective view. The wheels of the bicycle F are both dismounted here and not shown. The bicycle is fastened by its fork dropout G in one of two brackets 1 on the clamping beam 3, which has rollers 2 at the sides for better movement in a vehicle (not shown). A rear receptacle 11 is arranged on the frame 8 with supporting leg 9 and carries at least one additional bracket 1. In this additional bracket 1, the rear dropout H of the bicycle is fastened, being thus especially firmly fastened to the transport device at two connection points. The depicted bicycle F could likewise be arranged with the rear dropout H at the bracket 1 on the clamping beam 3 and with the fork dropout G on the bracket 1 at the rear receptacle 11. In especially space-saving manner several bicycles can be transported on the transport device if they are fastened pointing alternately forward and backward. The depicted embodiment enables a shorter structural length of the frame 8 and is thus also suited to smaller vehicles, especially those with a liftback.

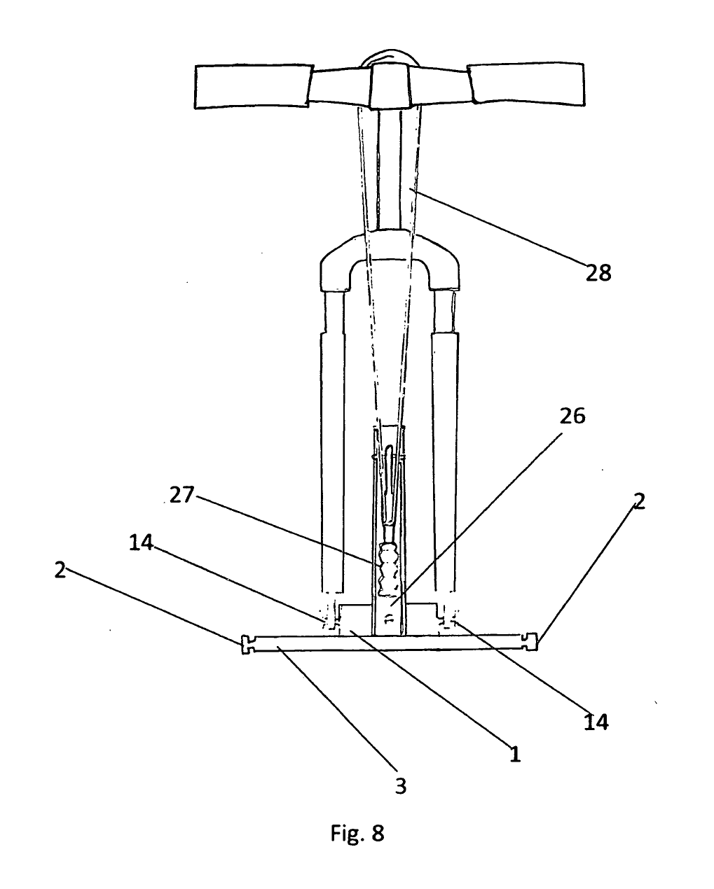

FIG. 8 shows a simple embodiment of a stretching device to shorten the height of a spring-suspension bicycle. With it, the overall height or parking height of the combination of mounted bicycle and transport device can be shortened to enable a use in vehicles having only slight stowage height. Such a device has, for example, a bracket 26 for the stretching device 27. With the stretching device 27, which in its simple form is a tension lever, a tension mechanism such as a cable 28 that grasps a part of the bicycle arranged above the suspension is pulled or pressed downward. According to the invention, it is of course possible to fasten the stretching device 27 directly on the transport device, such as the bracket 1 or the clamping beam 3 or the longitudinal connection element (not shown).

Each part of the transport device is preferably made from metal, plastic, or composite material, or a combination of several materials.

### REFERENCE NUMBERS

1 bracket
2 support
3 clamping beam
4 socket pins
5 fastening recess, borehole, groove
6 free
7 front parking surface
8 frame
9 supporting leg
10 supporting arm
11 rear receptacle
12 transport case
13 connection
14 fork receptacle
15 tension lever
16 recess
17 clip
18 beam
19 locking
20 leg
21 web
22 cross braces
23 connecting rod
24 knob
25 opposite end
26 bracket for stretching device
27 stretching device
28 cable
P vehicle
F bicycle
R wheel
G fork dropout
H rear dropout

What is claimed is:

1. A transport device to accommodate at least one transport good for transport in a vehicle, comprising: at least one bracket for connection to one part of the transport good, wherein a support is provided that allows a displacement of the transport device relative to the vehicle.

2. The transport device according to claim 1, wherein the support has rollers and/or slides.

3. The transport device according to claim 1, wherein the device has a clamping beam, which has at least one bracket, and the bracket can be adjusted along the clamping beam.

4. The transport device according to claim 3, wherein a front parking surface is provided on the clamping beam and/or the clamping beam is flat in configuration.

5. The transport device according to claim 1, wherein a frame is provided, which is carried by the support at one end.

6. The transport device according to claim 5, wherein at least one supporting leg is provided at one end of the frame away from the support.

7. The transport device according to claim 6, wherein the supporting leg is adjustable in height and/or can pivot and/or can be locked.

8. The transport device according to claim 1, wherein the transport good is a bicycle.

9. The transport device according to claim 5, wherein a supporting arm is pivoted on the frame, which is suitable to support the transport good at a bottom bracket ball bearing race.

10. The transport device according to claim 5, wherein a rear receptacle to support the transport good is arranged on the frame.

11. The transport device according to claim 2, wherein the device has a clamping beam, which has at least one bracket, and the bracket can be adjusted along the clamping beam.

12. The transport device according to claim 11, wherein a front parking surface is provided on the clamping beam and/or the clamping beam is flat in configuration, and wherein a frame is provided, which is carried by the support at one end.

13. The transport device according to claim 12, wherein at least one supporting leg is provided at one end of the frame away from the support, and wherein the supporting leg is adjustable in height and/or can pivot and/or can be locked.

14. The transport device according to claim 13, wherein the transport good is a bicycle.

15. The transport device according to claim 14, wherein a supporting arm is pivoted on the frame, which is suitable to support the bicycle at a bottom bracket ball bearing race.

16. The transport device according to claim 15, wherein a rear receptacle to support the bicycle is arranged on the frame.
